(19) United States
(12) Patent Application Publication
(10) Pub. No.: US 2023/0395048 A1
(43) Pub. Date: Dec. 7, 2023

(54) DETERMINING AUDIO OUTPUT FOR AQUACULTURE MONITORING MODELS

(71) Applicant: X Development LLC, Mountain View, CA (US)

(72) Inventors: Grace Calvert Young, Mountain View, CA (US); Laura Valentine Chrobak, Menlo Park, CA (US); Kathy Sun, Boulder Creek, CA (US)

(21) Appl. No.: 17/833,132

(22) Filed: Jun. 6, 2022

(51) Int. Cl. G10H 1/00; A01K 29/00

(52) U.S. Cl. CPC G10H 1/0025; A01K 29/005; G10H 2210/111; G10H 2250/005; G10H 2210/145; A01K 61/00

(57) ABSTRACT

Methods, systems, and apparatus, including medium-encoded computer program products, for receiving outputs from a plurality of models that are each informed by real-time data provided by one or more sensors that are present in an aquaculture environment. An input is generated for an algorithmic music composer for algorithmically composing music that reflects multiple current conditions within the aquaculture environment, based at least on the received outputs from the plurality of models. The input is provided to the algorithmic music composer to algorithmically compose the music that reflects the multiple current conditions within the aquaculture environment.

### TECHNICAL FIELD

This specification relates to using the outputs of aquaculture monitoring models, e.g., machine learning models configured to make predictions regarding the current and future state of an aquaculture environment, to determine audio output that can enhance monitoring of the aquaculture environment.

### BACKGROUND

Aquaculture involves the farming of aquatic livestock, such as fish, crustaceans, or aquatic plants. In aquaculture, and in contrast to commercial fishing, freshwater and saltwater livestock populations are cultivated in controlled environments. For example, the farming of fish can involve raising fish in tanks, fish ponds, or ocean enclosures.

Aquaculture environments are extremely complex as they are influenced by the livestock, weather, water condition, lighting, feeding schedules, other organisms in the environment, among other factors. In addition, to ensure the health of the livestock, the environment must be monitored on a constant or near-constant basis.

### SUMMARY

This specification describes technologies related to determining audio output for aquaculture monitoring models. The audio outputs can be rendered to improve aquaculture monitoring systems.

Particular embodiments of the subject matter described in this specification can be implemented so as to realize one or more of the following advantages. The techniques described below can be used to simplify the monitoring and management of aquaculture environments by generating audio outputs that are descriptive of conditions in the environment. In addition, by encoding such conditions as audio output, the techniques enable monitoring of aquaculture environments over a longer duration. Further, the techniques of this specification simplify training by encoding conditions tailored to a particular individual or category of individuals. The techniques of this specification also enable users with sensory challenges to participate in aquaculture. For example, a person with a visual impairment might be challenged to monitor visual signals, but would not be similarly challenged with audio. In addition, at the times when the environment does not require complete attention, the techniques of this specification allow a user to continue monitoring the environment, while also performing other tasks.

One aspect features receiving outputs from a plurality of models that are each informed by real-time data provided by one or more sensors that are present in an aquaculture environment. An input is generated for an algorithmic music composer for algorithmically composing music that reflects multiple current conditions within the aquaculture environment, based at least on the received outputs from the plurality of models. The input is provided to the algorithmic music composer to algorithmically compose the music that reflects the multiple current conditions within the aquaculture environment.

One or more of the following features can be included. Generating the input can include processing one or more features using a machine learning model. The features can include an indicator of one or more target users. The input can be generated in real-time. The input can describe characteristics of sound. The input can identify one or more songs. Generating the input can include evaluating a plurality of rules. The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of an environment for determining audio output for aquaculture monitoring models.

FIG. 2 is a flow diagram of an example process for determining audio outputs related to aquaculture conditions.

FIG. 3 is a block diagram of an example computer system.

Like reference numbers and designations in the various drawings indicate like elements.

### DETAILED DESCRIPTION

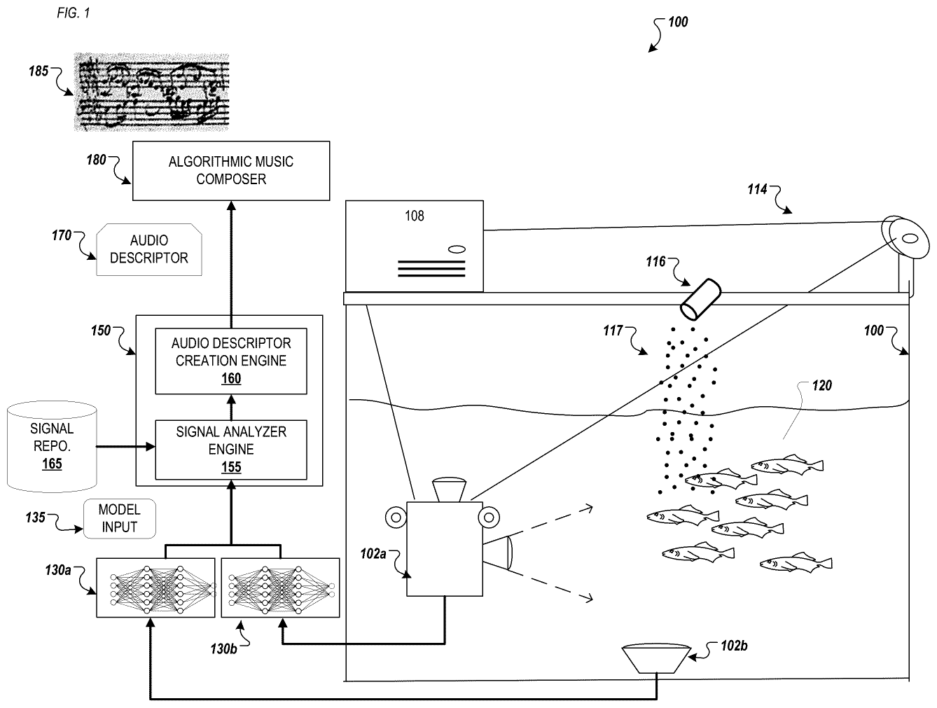

FIG. 1 shows an example of an environment for determining audio output for aquaculture monitoring models.

Aquaculture includes the farming of marine organisms such as fish, crustaceans and mollusks. Aquaculture is important to the health of marine ecosystems, which can suffer from overharvesting. Experience indicates over half of all fish and shellfish consumed by humans come from aquaculture, and in the absence of aquaculture, substantial, and perhaps irreversible, strain on marine ecosystems could result.

Many factors create challenges for operating an effective aquaculture environment. One example is parasites, such as sea lice, which can cause skin erosion and hemorrhaging, gill congestion, and increased mucus production. Parasites harm both the welfare of the organisms being farmed, and the yield produced by an aquaculture environment. Another challenge is proper feeding, as the livestock must be fed at the correct times and correct amounts. The correct amount of feed is important to monitor as feeding an incorrect amount can have negative effects of animal welfare. Additionally, feeding too much can negatively impact the surrounding marine environment by eutrophying the water and wasting costly fish feed. Still another example is weather, as extreme weather can harm the livestock. For these reasons, effective monitoring of the aquaculture environment is of paramount importance.

Various monitoring and analysis techniques have been developed and deployed to aid in the operation of aquaculture environments. For example, machine learning models have been used to detect parasitic infections and to ensure proper feeding.

However, while some existing monitoring techniques are quite sophisticated, aquaculture environments are extremely complex, and unforeseen situations can arise. To mitigate adverse conditions, humans must provide oversight, which requires simultaneously monitoring numerous signals, including both raw data and the output of various analysis components, and which can relate to multiple sites and environments. In addition, at times, the environment can require sustained attention, which can introduce the opportunities for errors if a human becomes distracted, and can strain the wellness of human monitors.

The techniques described in this specification can simplify the task of monitoring a complex aquaculture environment. As described further below, signals from various monitoring and analysis components are provided to an audio output determination system that uses the signals to select characteristics of sounds (e.g., music) that can represent the state of the aquaculture environment. The audio output determination system can use those characteristics to create audio descriptors that it can provide to an algorithmic music composer, which can create, select or combine one or more musical scores that both represent the state of the aquaculture environment and are readily consumable by humans monitoring the environment. The resulting audio can aid human understanding of the aquaculture environment, such as livestock physiology, hunger, and mood. Such information is valuable because it can allow farmers at fish farms to make better decisions, e.g., when and how to feed the livestock, when and how to treat disease, and so on.

Returning to FIG. 1, the environment 100 can include an aquaculture enclosure 110, one or more sensor data analysis components 130a, 130b (collectively referred to as sensor data analysis components 130), an audio output determination system 150, a signal repository 165 and an algorithmic music composer 180.

The enclosure 110 may enclose livestock 120 that can be aquatic creatures which can swim freely within the confines of the enclosure 110. In some implementations, the aquatic livestock 120 stored within the enclosure 110 can include finfish or other aquatic lifeforms. The livestock 120 can include, for example, juvenile fish, koi fish, salmon, bass, bivalves or crustaceans, e.g., shrimp, to name a few examples.

In addition to the aquatic livestock 120, the enclosure 110 contains water, e.g., seawater, freshwater, or rainwater, although the enclosure can contain any fluid that is capable of sustaining a habitable environment for the aquatic livestock 120.

In some implementations, the enclosure 110 may be anchored to a structure such as a pier, dock, or buoy. For example, instead of being confined within the enclosure 110, the livestock 120 can be free to roam a body of water, and sensors 102 can be used to monitor livestock 120 within a certain area of the body of water without the enclosure 110.

The enclosure 110 can include a winch system 114 and one or more sensor subsystems 102a, 102b (collectively referred to as sensor subsystems 102). The winch subsystem 108 may move a camera sensor subsystem 102a up and down to different depths in the enclosure 110. For example, the camera sensor subsystem 102a may patrol up and down within the enclosure 110 while it monitors fish feeding. The winch subsystem 108 can include one or more motors, one or more power supplies, and one or more pulleys to which the cord 114, which suspends the camera sensor subsystem 102a, is attached. A pulley is a machine used to support movement and direction of a cord, such as cord 114. Although the winch subsystem 108 includes a single cord 114, any configuration of one or more cords and one or more pulleys that allows the camera sensor subsystem 102a to move and rotate, as described herein, can be used.

The winch subsystem 108 may activate one or more motors to move the cord 114. The cord 114, and the attached camera sensor subsystem 102a, can be moved along the x, y, and z-directions, to a position corresponding to the instruction. A motor of the winch subsystem 108 can be used to rotate the camera sensor subsystem 102a to adjust the horizontal angle and the vertical angle of the sensor subsystem. A power supply can power the individual components of the winch subsystem. The power supply can provide AC and DC power to each of the components at varying voltage and current levels. In some implementations, the winch subsystem can include multiple winches or multiple motors to allow motion in the x, y, and z-directions.

Each camera sensor subsystem 102a can include one or more image capture devices that can point in various directions, such as up, down, to any side, or at other angles. Each camera sensor subsystem 102a can take images using any of its included imaging devices, and an enclosure 110 can contain multiple camera sensor subsystems 102a.

The data provided by the sensors 102 can also include metadata about sensor reading. Such metadata can include an identifier of the sensor subsystem 102 that captured the reading, the time the reading was captured, the location of the sensor (e.g., the depth of the camera subsystem 102a) at the time the reading was taken, and so on.

The environment 100 can include one or more feeding mechanisms 116 that can provide feed 117 to the livestock 120. The feeding mechanism 116 can include a pipe connecting the enclosure 110 to a central feeding station that provides the feed 117 to the enclosure 110. In some implementations, a distributor located at the enclosure 110 can be used to more evenly distribute the feed 117 within the enclosure 110. For example, the distributor can move around the surface of the enclosure 110 while dropping the feed 117 for the livestock 120. In some cases, a device can be used to propel the feed 117. For example, a blower that blows air or water with the feed 117 can be used to disperse the feed 117. Feeding mechanisms 116 can also include sensors that can monitoring the feeding process. For example, a feeding mechanism sensor can monitor the amount of feed disbursed over a given time period, the maximum and minimum rates of feed injection, and so on.

The environment 100 can include various additional sensors 102b. For example, the environment 100 can include sensors 102b that measure temperature at various locations within the environment. In another example, the environment 100 can also include sensors 102b that measure water properties such as dissolved oxygen, pH and salinity.

The sensor data analysis components 130 can each accept signals from one or more sensors 102 in the aquaculture enclosure 110, and produce model inputs 135. The sensor data analysis components 130 can include various models, including machine learning and mathematical models, that accept signals as input and produce model inputs 135 as results. For example, a signal can indicate lighting conditions within the enclosure 110, and a sensor data analysis component 130 can use the lighting conditions to produce a feeding recommendation encoded as a model input 135. In another example, a signal can indicate the presence of parasites on livestock 120, and a sensor data analysis component 130 can use the indication to produce a remediation recommendation encoded as a model input 135.

An audio output determination system 150 can include a signal analyzer engine 155 and an audio descriptor creation engine 160. The signal analyzer engine 155 can accept model inputs 135 produced by sensor data analysis components 130 and generate one or more audio descriptors representative of the state of the enclosure. The audio descriptors 170 are examples of audio output and serve as input to the algorithmic music composer 180, as described further below. The audio descriptors 170 can describe sounds, sound experience (e.g., emotions the audio is intended to invoke), songs, soundscapes, sound palettes, or other types of sound or music.

To produce audio descriptors 170, the signal analyzer engine 155 can include one or more analysis components such as rules engines, machine learning models, and other components (e.g., program code). The signal analyzer can apply analysis components to the model inputs 135 to produce audio indicators used by the audio descriptor creation engine 160 to produce audio descriptors 170.

An audio indicator can encode information relevant to creating an audio descriptor 170. In some implementations, an audio indicator can include properties of the music, such as beat, volume, mood, pitch, exemplary artist, genre, etc. In some implementations, an audio indicator can include a song indicator, such as a title or index into a song repository.

An audio indicator can include a prelude section that can include information that helps a fish feeder to choose among actions that occur before starting an operation such as depositing feed or administering treatment. For example, an audio indicator can start in a high-pitch if fish are near the surface and low pitch if fish are deeper. The audio indicator can reflect pitch adjustments with complementary information such as low dissolved oxygen levels from high algae bloom in shallow water, lice infestations, and distribution of fish in the pen. For example, the audio indicator can convey complex information such as “most fish are shallow, but there is a high lice infestation in shallow water and low dissolved oxygen in that region, so if fish are brought deeper it will bring more a harmonious sound.” The feeder can use this information to determine the optimal location for the feeder.

In another example, an audio indicator can encode a slow tempo if there are indicators that fish are likely not hungry. Such indicators can include slow swimming, slack tide, low dissolved oxygen, cold temperatures, (since fish metabolism can slow in colder water), and/or history of prior feedings. The feeder can match the slow tempo with a slow feeding rate, and if the song has an exceedingly slow tempo, the feeder may choose to skip the feeding.

In another example, the audio indicator can include riffs particular to diseases present in the pen and the prevalence of each disease. Examples of diseases can include, for example, pancreatic disease, cardio-vascular diseases and flesh wounds. Each disease can have a unique riff, e.g., similar to how each villain in an opera can have its own theme music. Each disease type can have a characteristic riff, and several riffs can be present in one audio indicator. If disease levels are high, its riff can be repeated; if disease levels are low, the riffs can be present but difficult for a human to recognize.

In still other examples, if disease levels are high, the audio indicator can carry tension, which can induce the farmer to worry about the pen, and become motivated to take action. If fish have surface wounds, they may need feed that helps their immune systems to fight infections. If the farmer has chosen types of feed that may help alleviate diseases, or taken other action to alleviate the disease, then its character riff may dissipate since all possible action have occurred. If no actions are taken, the tension riff (dissonance, which is adding a note to a chord) can continue.

In a further example, after a feeder has made initial decisions, e.g., based on the prelude encoded by an audio indicator, the audio indicator can convey additional information. Information encoded in the audio indicator can include a recommended rate of feed delivered to the pen, which can be indicated by the tempo of a unique instrument. For example, that instrument can play at a fast tempo if feed is given at a quick rate and a slow tempo if the feed is given at slow rate. The instrument can be absent when the feeder is off.

If fish are not consuming missing pellets (i.e., there is a high fall-through rate), then the instrument's riffs can be immediately followed by a discordous note since the feed rate should match appetite. This instrument can be harmonious with the instruments indicating fish appetite (as described above). If fish are being fed at a rate faster than they are eating, then the audio indicator can encode sounds intended to give the feeder emotional tension as it means feed is being wasted, which causes water pollution and an undesirable raising feed conversion ratio. The rate of pellet fall-through can be conveyed by the tempo of a separate instrument.

If the models predict that a faster feed rate would be advantageous (e.g., high winds or heavy rain are making feed soggy), the audio indicator can also encode discord. A character riff conveying tension can be present in the audio indicator if large fish are being fed, but small and/or sickly fish are not. In such cases, the feeder can react by moving the feeder such that feed reaches fish more equally, or waiting until later in day, when sickly fish may be closer to the feeder, to deposit food. The audio indicator can encode a more harmonious “hero's riff” that balances the feeding approach until both riffs fade when fish are equally fed.

The audio indicator can include an appetite-indicating instrument and tempo, and can be adjusted, by factors including: (i) swimming speed (e.g., faster swimming can indicate higher metabolism and appetite); (ii) swimming directions (e.g., upward swimming can indicate reaching for food); (iii) acceleration (e.g., higher acceleration can indicate higher metabolism and appetite, and potentially aggressive behavior; a frenzied level can indicate an eagerness for food); and (iv) dissolved oxygen in the water (e.g., higher dissolved oxygen can indicate that fish have a slower metabolism because they do not need to swim as fast to get oxygen over their gills). Such factors can be measured by sensors present in the environment.

To create the model inputs, the signal analyzer engine can also obtain information from a signal repository 165. The signal repository 165 can store signals produced by the sensors 102 in the enclosure 102, and data provided by other sources. For example, the signal repository 165 can include historical weather data and weather prediction data.

The signal repository 165 can be any appropriate data storage system. For example, the signal repository can be a relational database, an object database, an unstructured database, file storage, block storage, and so on. In addition, while the signal repository 165 is shown as being outside of and coupled to the audio output determination system 150, in some implementations, the signal repository 165 can be a component of the audio output determination system 150.

The audio descriptor creation engine 160 can accept an audio indicator from the signal analyzer engine 155, and create an audio descriptor 170. The audio descriptor creation engine 160 can, for example, translate the music indicator into the audio descriptor format appropriate for a particular algorithmic music composer 180. An audio descriptor 170 can be encoded in any format suitable for the algorithmic music composer 180.

The algorithmic music composer 180 can accept one or more audio descriptors and produce music data 185. The music data 185 can be encoded in any appropriate format such as Moving Picture Experts Group (MPEG) Layer-3 Audio (MP3), MPEG 4 Audio (MP4A), Free Lossless Audio Codec (FLAC), Waveform Audio File Format (WAV), and so on. The music data 185 can also indicate whether the music is to be played once or multiple times, e.g., for a specified number of iterations, until a condition is met, until it is stopped manually, etc.

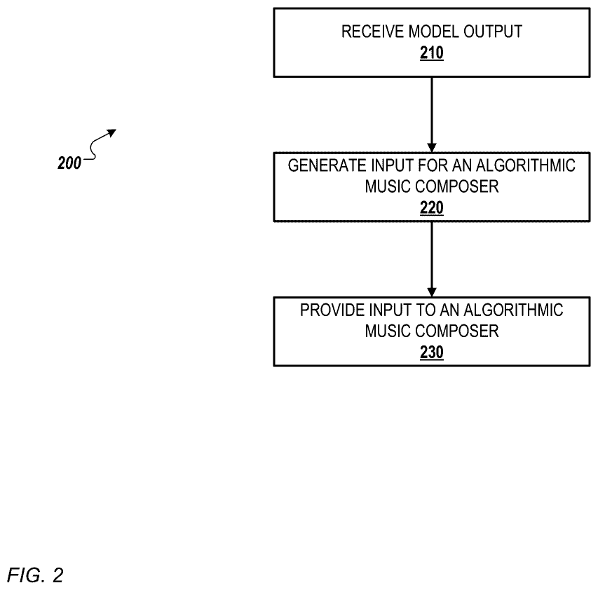

FIG. 2 is a flow diagram of an example process for determining audio output for aquaculture monitoring models. For convenience, the process 200 will be described as being performed by a system for determining audio output for aquaculture monitoring models, e.g., the audio output determination system 150 of FIG. 1, appropriately programmed to perform the process. Operations of the process 200 can also be implemented as instructions stored on one or more computer readable media which may be non-transitory, and execution of the instructions by one or more data processing apparatus can cause the one or more data processing apparatus to perform the operations of the process 200. One or more other components described herein can perform the operations of the process 200.

The system receives (210) model input. The system can receive model input from sensors, such as sensors coupled to an aquaculture environment, and from one or more sensor data analysis components. The system can receive the model input using any appropriate protocol. In some implementations, the system provides an application programming interface (API) and sensors and sensor data analysis components can call the API to provide model input. In some implementations, the system can receive model input over a direct connection (e.g., using the Peripheral Component Interconnect (PCI) protocol) and/or over a network (e.g., using Transmission Control Protocol/Internet Protocol (TCP/IP)).

The system generates (220) input, such as an audio descriptor, for an algorithmic music composer. In some implementations, the system can generate the input using two stages: (i) a signal analysis phase in which the system determines an audio indicator, and (ii) an audio descriptor creation phase.

The signal analysis phase can accept model input, and apply one or more analysis components to the model input to produce an audio indicator. The analysis components can evaluate signals available to the system and use the signals when producing audio indicators.

In some implementations, the analysis components can include a machine learning model that is configured to accept features and to produce an audio indicator. The features can include model inputs and other signals. The model inputs can include signals produced by sensors in the aquaculture environment, signals produced by one or more sensor data analysis components, and signals stored in a signal repository. The signals produced by sensor data analysis components can include analysis results (e.g., parasites are present) and recommendations (e.g., feeding should commence). The signals retrieved from the signal repository can include historical analysis results, historical recommendations, prior sensor data, weather data, weather forecast, etc. In some implementations, the features can include a target user, a list of target users, properties or preferences of one or more target users, or other information related to the consumer of the music. The machine learning model can be configured to produce audio indicators determined for the user or users. The system can process an input that includes the features using the machine learning model to produce an audio indicator.

In some implementations, the system can include a rules engine that accepts signals (as described above, and which can include information relevant to target users) and produces an audio indicator. The rules engine can evaluate rules that include predicates and results, where the results can be signals and music indictors. When the result of a rule evaluation produces a signal, the signal can be used to evaluate predicates of other rules. In some implementations, the rules are encoded as Prolog rules, and the signal can be encoded as Prolog facts. The system can include a conventional Prolog interpreter to process the signals (facts) using the configured rules.

The audio descriptor creation phase can accept one or more audio indicators produced by the signal analysis phase and create an audio descriptor configured for an algorithmic music composer. In some implementations, the audio descriptor creation phase accepts an audio indicator, and produces Extensible Markup Language (XML) according to a schema used by a particular algorithmic music composer. The system can translate the data in an audio descriptor into XML that conforms to such a schema.

As described above, the audio indicator can include properties of the music (e.g., beat and volume), a song indicator (e.g., one or more song titles, or combinations of music properties and song indicators. In one example, an audio indicator can include a song title and song properties (e.g., that the song should be acoustic). In another example, an audio indicator can include a list of song titles, and optionally include a song order. In some examples, the audio indicator can include combinations of song titles and properties of the music. For example, the audio indicator might specify a list of five songs, and properties of other songs to be included in the audio descriptor.

The audio indicator can reflect properties of the environment. In one example, the audio indicator can reflect concern if disease is present. A sound palette representing concern can be minor if disease levels are low (e.g., under 0.1% of the livestock in the pen are impacted), and overwhelming and frequently repeated if disease levels are high (e.g., over 30% of the livestock in a pen are impacted). Other palettes can reflect unease of the livestock are not properly fed, joy if the livestock are healthy, lethargy when dissolved oxygen levels are below a configured threshold (since fish metabolism can slow when dissolved oxygen is low), harmony and maturity when fish are schooling, clashing and discord when fish are not schooling, anxiety when the livestock are determined to be stressed (e.g., by detecting color changes in some fish), among many other examples.

As described further below, the created audio indicators can change in real-time, creating a feedback loop for the farmer. For example, audio indicators can reflect music that becomes more harmonious when the feeding is going well, and audio indicators that produce music that is harsh can indicate that feeding needs to change. The audio indicators can become more harmonious as livestock welfare states improve.

The system can generate the audio indicators at various intervals. In some implementations, the system generates audio indicators in real-time—that is, the system generates audio indicators as model input arrives, and the system can stream the generated inputs to an algorithmic music composer as they are produced. Real-time determination of audio descriptors can help improve real-time decision-making, including decisions that are based on vast amounts of real-time data.

In addition, by providing audio descriptors in real-time, users can make immediate environmental adjustments, and evaluate the results of the adjustments in real-time, creating a real-time feedback loop from complex data that can help to improve user performance and aquaculture conditions.

In some implementations, the system can accumulate model input and produce audio descriptors. For example, the system can produce audio descriptors at configured intervals (e.g., 1 minute, 5 minutes, 10 minutes, etc.). In some implementations, the system can receive an indication that the system should produce an audio descriptor, e.g., if a user has exhausted previously provided music. In some implementations, the system can determine that it should produce an audio descriptor. For example, if the system detects that the received model input changes by a configured amount or percentage, the system can generate an audio descriptor.

The system provides (230) input to an algorithmic music composer. The system can provide the input using any appropriate protocol. In some implementations, the system calls an API provided by the algorithmic music composer to provide the input. In some implementations, the system can provide the input over a direct connection (e.g., Peripheral Component Interconnect (PCI)) and/or over a network (e.g., Transmission Control Protocol/Internet Protocol (TCP/IP)).

The algorithmic music composer can use the audio descriptors to create tones such as notes, chords, and/or riffs. Together, the tones can form a sequence that conveys information through patterns, volume, tempo, and so on, as described above. For example, certain sounds are universally alarming, frenzied, or calm to humans; these can be used to transmit information about fish (e.g., diseases of concern to the farmer), and in some cases, better than graphs or dashboards which can take months of human training and memorization to interpret.

In addition, the algorithmic music composer can smooth-over sounds for an engaging listening experience, and to avoid jarring music, except when such jarring is intended. In some examples, factors encoded as continuous values can be mapped to a tempo (e.g., slow or fast), while factors encoded as discrete can be assigned a riff (e.g., a character sequence, as described further below). Factors with large influence can be dominant in a song, while factors with minor influence can be less dominant.

In response to hearing the sounds, the feeder can make adjustment, including altering: (a) the rate feed is given (e.g., the rate can be increased if the audio descriptor indicates that fish are eating quickly); (b) the time of day feed is given; (c) the location of feeding within the pen (e.g., shallow or deep, to center or edge); and (d) the type of feed (e.g., introduce feed with added medication or nutrients).

In some implementations, a fish farm operation can save the fish behavior and associated feeding songs from each day. The recordings can be used to train feeders, demonstrating the sounds of well-fed pens and pens that were optimally fed. In addition, even absent training, feeders can be affected by the emotions conveyed in the song, which can drive the feeders towards appropriate actions such as increasing feed, slowing feed, or administering treatment. Further, the audio descriptor can be provided as a predictive variable for other factors, such as cortisol levels or other tangible wellness indicators, when given sufficient training data.

As should be apparent from the preceding discussion, effectively managing an aquaculture environment requires monitoring myriad signals, which can overwhelm humans. As a result, humans can overlook subtleties of fish behavior that are important indicators of fish wellbeing and appetite. In addition, because humans can be overwhelmed with information, they often default to convenient patterns (e.g., feeding right after human lunch), even though they may be suboptimal for the fish. Further, no single source of information is sufficient to make optional decisions, and integrating the source of information can require exhaustive training.

While the descriptions in this specification have largely described techniques in the context of aquaculture, the techniques can also be used in other environments. For example, in an agriculture environment, sensors can monitor factors relevant to livestock such as cows, pigs, chickens, and so on. Such factors can include livestock behavior (e.g., the speed and location of movement), weather (temperature, humidity, wind, sunlight, etc.), available feed (both feed that is introduced by the farmers and feed such as grass that is naturally available), defects in the enclosure (e.g., breaks in a fence), among many other examples. Models can analyze the sensor data to produce predictions and recommendations, such as increasing or decreasing feeding, changing feeding location, ensuring that shelter is available, removing a predator, and so on.

The techniques can then be used to produce audio descriptors from audio indicators. For example, aggressive behavior detected by the models can be encoded as shrill sounds (e.g., loud and high pitched), indicating that the farmer should consider taking immediate action to ensure the health of the livestock. In another example, frequent vocalizations by the livestock could indicate hunger, and the techniques can be used to produce audio descriptors that reflect a need to provide feed, and optionally a location that the feed should be provided. In still another example, certain types of vocalizations can be associated with livestock discomfort, and the techniques can be used to produce audio descriptors that reflect a recommended remediation. For example, if a particular vocalization is associated with a particular malady, the audio descriptor can encode the need to provide veterinary care.

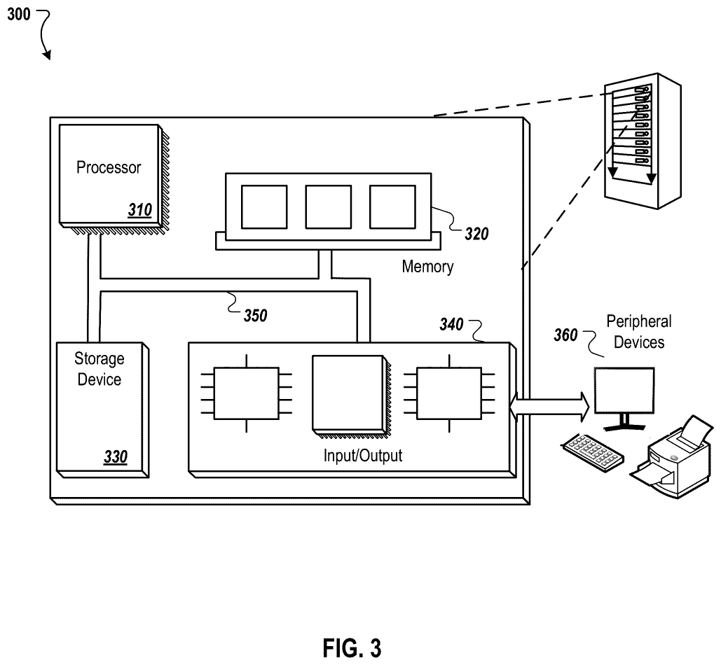

FIG. 3 is a block diagram of an example computer system 300 that can be used to perform operations described above. The system 300 includes a processor 310, a memory 320, a storage device 330, and an input/output device 340. Each of the components 310, 320, 330, and 340 can be interconnected, for example, using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 can include, for example, a hard disk device, an optical disk device, a storage device that is shared over a network by multiple computing devices (e.g., a cloud storage device), or some other large capacity storage device.

The input/output device 340 provides input/output operations for the system 300. In one implementation, the input/output device 340 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 360. Other implementations, however, can also be used, such as mobile computing devices, mobile communication devices, set-top box television client devices, etc.

Although an example processing system has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computing device capable of providing information to a user. The information can be provided to a user in any form of sensory format, including visual, auditory, tactile or a combination thereof. The computing device can be coupled to a display device, e.g., an LCD (liquid crystal display) display device, an OLED (organic light emitting diode) display device, another monitor, a head mounted display device, and the like, for displaying information to the user. The computing device can be coupled to an input device. The input device can include a touch screen, keyboard and a pointing device, e.g., a mouse or a trackball, by which the user can provide input to the computing device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer-implemented method comprising:
receiving outputs from a plurality of models that are each informed by real-time data provided by one or more sensors that are present in an aquaculture environment;
generating an input for an algorithmic music composer for algorithmically composing music that reflects multiple current conditions within the aquaculture environment, based at least on the received outputs from the plurality of models; and
providing the input to the algorithmic music composer to algorithmically compose the music that reflects the multiple current conditions within the aquaculture environment.

2. The computer-implemented method of claim 1, wherein generating the input comprises processing one or more features using a machine learning model.

3. The computer-implemented method of claim 2, wherein the features include an indicator of one or more target users.

4. The computer-implemented method of claim 1, wherein the input is generated in real-time.

5. The computer-implemented method of claim 1, wherein the input describes characteristics of sound.

6. The computer-implemented method of claim 1, wherein the input identifies one or more songs.

7. The computer-implemented method of claim 1 wherein generating the input comprises evaluating a plurality of rules.

8. A system comprising one or more computers and one or more storage devices storing instructions that when executed by the one or more computers cause the one or more computers to perform operations comprising:
receiving outputs from a plurality of models that are each informed by real-time data provided by one or more sensors that are present in an aquaculture environment;
generating an input for an algorithmic music composer for algorithmically composing music that reflects multiple current conditions within the aquaculture environment, based at least on the received outputs from the plurality of models; and
providing the input to the algorithmic music composer to algorithmically compose the music that reflects the multiple current conditions within the aquaculture environment.

9. The system of claim 8, wherein generating the input comprises processing one or more features using a machine learning model.

10. The system claim 9, wherein the features include an indicator of one or more target users.

11. The system of claim 8, wherein the input is generated in real-time.

12. The system of claim 8, wherein the input describes characteristics of sound.

13. The system of claim 8, wherein the input identifies one or more songs.

14. The system of claim 8, wherein generating the input comprises evaluating a plurality of rules.

15. One or more non-transitory computer-readable storage media storing instructions that when executed by one or more computers cause the one or more computers to perform operations comprising:
receiving outputs from a plurality of models that are each informed by real-time data provided by one or more sensors that are present in an aquaculture environment;
generating an input for an algorithmic music composer for algorithmically composing music that reflects multiple current conditions within the aquaculture environment, based at least on the received outputs from the plurality of models; and
providing the input to the algorithmic music composer to algorithmically compose the music that reflects the multiple current conditions within the aquaculture environment.

16. The one or more non-transitory computer-readable storage media of claim 15, wherein generating the input comprises processing one or more features using a machine learning model.

17. The one or more non-transitory computer-readable storage media of claim 16, wherein the features include an indicator of one or more target users.

18. The one or more non-transitory computer-readable storage media of claim 15, wherein the input is generated in real-time.

19. The one or more non-transitory computer-readable storage media of claim 15, wherein the input describes characteristics of sound.

20. The one or more non-transitory computer-readable storage media of claim 15, wherein the input identifies one or more songs.
